(19) United States
(12) Patent Application Publication
(10) Pub. No.: US 2013/0077467 A1
(43) Pub. Date: Mar. 28, 2013

(54) RECEIVER IN ORTHOGONAL FREQUENCY DIVISION MULTIPLE ACCESS SYSTEM AND SIGNAL PROCESSING METHOD THEREOF

(71) Applicant: SNU R&DB FOUNDATION, Seoul (KR)

(72) Inventors: Jong-Seon No, Seoul (KR); Dong-Joon Shin, Seoul (KR); Hyun-Seung Joo, Seoul (KR); Kee-Hoon Kim, Daejeon (KR)

(73) Assignee: SNU R&DB FOUNDATION, Seoul (KR)

(21) Appl. No.: 13/627,046

(22) Filed: Sep. 26, 2012

(30) Foreign Application Priority Data
Sep. 27, 2011 (KR) 10-2011-0097625
Sep. 26, 2012 (KR) 10-2012-0107145

(51) Int. Cl. H04J 11/00

(52) U.S. Cl. 370/210

(57) ABSTRACT

According to an exemplary embodiment of the present invention, a receiver in an orthogonal frequency division multiple access (OFDMA) system includes: an extraction unit that extracts received user signal subvectors for subcarriers assigned to the receiver from received signal vectors received from a transmitter; and a fast Fourier transform (FFT) unit that performs a fast Fourier transform on the received user signal subvectors.

### CROSS-REFERENCE TO RELATED APPLICATION

This application claims priority to and the benefit of Korean Patent Application No. 10-2011-0097625 and 10-2012-0107145 filed in the Korean Intellectual Property Office on Sep. 26, 2011 and Sep. 27, 2012, the entire contents of which are incorporated herein by reference.

### BACKGROUND OF THE INVENTION

(a) Field of the Invention

The present invention relates to a receiver in an OFDMA system and a signal processing method thereof.

(b) Description of the Related Art

In order to transmit multimedia data in real time in a wireless communication environment, a demand for a fast data transmission system of 100 Mbps or higher has increased. Therefore, an interest in an orthogonal frequency division multiplexing (OFDM) technology has increased. The OFDM technology has been widely adopted as a standard of several wireless communication systems.

A system that assigns subcarriers to several users based on the OFDM technology is referred to as an orthogonal frequency division multiple access (OFDMA) system. According to the OFDMA system, an available frequency band is divided into a plurality of subchannels and then, data are carried on subcarriers corresponding to each subchannel in parallel and are transmitted.

At a transmitting terminal of the OFDMA system, signal processing is performed based on an inverse fast Fourier transform (IFFT) and at a receiving terminal thereof, signal processing is performed based on a fast Fourier transform (FFT). The IFFT and the FFT have high computational complexity. Therefore, the IFFT and the FFT have a big impact on power consumption of a terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a receiver having low computational complexity in an OFDMA system and a signal processing method thereof.

An exemplary embodiment of the present invention provides a receiver in an orthogonal frequency division multiple access (OFDMA) system, including: an extraction unit that extracts received user signal subvectors for subcarriers assigned to the receiver from received signal vectors received from a transmitter; and a fast Fourier transform (FFT) unit that performs a fast Fourier transform on the received user signal subvectors.

The extraction unit may perform circular convolution on the received signal vectors and the user signal extraction vectors, and convert the received user signal vectors into received user signal subvectors.

The user signal extraction vectors may be defined for each receiver.

The FFT unit may perform a fast Fourier transform on the received user signal subvectors to extract received user symbol subvectors.

When the received signal vectors are received signal vectors of N subcarriers assigned to M receivers, the FFT unit of each user may perform an N/M-point FFT.

Another exemplary embodiment of the present invention provides a signal processing method of a receiver in an orthogonal frequency division multiple access (OFDMA) system, including: extracting received user signal subvectors for subcarriers assigned to the receiver from received signal vectors received from a transmitter; and performing a fast Fourier transform on the received user signal subvectors.

The received user signal subvectors may be extracted by performing circular convolution on the received signal vectors and user signal extraction vectors, and by conversion of received user signal vectors into received user signal subvectors.

The user signal extraction vectors may be defined for each user.

The user signal extraction vectors may have nonzero elements that correspond to the total number of users.

When the received signal vectors are received signal vectors of N subcarriers assigned to M receivers, the FFT unit of each user may perform an N/M-point FFT.

Received user symbol subvectors for the receiver may be extracted as a result of the fast Fourier transform.

When the received signal vectors may be received signal vectors for N subcarriers assigned to M receivers, the received user symbol subvectors are configured of N/M data symbols.

According to the exemplary embodiment of the present invention, it is possible to remarkably reduce the computational complexity at the time of performing the existing N-point FFT of the receiver in the OFDMA system. As a result, it is possible to reduce the power consumption of the terminal.

### BRIEF DESCRIPTION OF THE DRAWINGS

FIG. 1 is a diagram illustrating an example of allocating subcarriers based on an interleaving scheme in an OFDMA system.

FIG. 2 is a diagram illustrating an example of a transmitter of the OFDMA system and FIG. 3 is a diagram illustrating an example of a receiver of the OFDMA system.

FIG. 4 is a diagram illustrating the receiver of the OFDMA system according to an exemplary embodiment of the present invention.

FIG. 5 is a diagram illustrating in detail a demodulation process of the receiver of the OFDMA system according to an exemplary embodiment of the present invention.

FIG. 6 is a graph illustrating results obtained by comparing complex multiplications in the existing N-point FFT and the proposed demodulation scheme according to an exemplary embodiment of the present invention.

FIG. 7 is a graph illustrating results obtained by comparing complex additions in the existing N-point FFT and the proposed demodulation scheme according to an exemplary embodiment of the present invention.

FIG. 8 is a graph illustrating results obtained by comparing the complex multiplications and the complex additions in the existing N-point FFT and the proposed demodulation scheme according to an exemplary embodiment of the present invention based on the number of flops.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising”, will be understood to imply the inclusion of stated elements but not the exclusion of any other elements.

It is assumed that in an orthogonal frequency division multiple access (OFDMA) system, N subcarriers that are orthogonal to each other are used.

Equation 1 is an example of input symbol vector X.

X=[X₀X₁ . . . X_{N-1}]^{T} (Equation 1)

In the above Equation 1, N is the number of subcarriers and (·)^{T} is a transpose of vector.

Signals for M users are divided into N data streams and are carried on N subcarriers. As Equation 2, when the input symbol vector X is subjected to IFFT, the OFDMA signal may be obtained depending on Equation 3.

$$\begin{matrix}x = IFFT ( X ) & ( Equation 2 ) \\ {x}_{n} = \frac{1}{\sqrt{N}} {\sum }_{k = 0}^{N - 1} {X}_{k} {e}^{j \frac{2 π kn}{N}} , 0 \leq n \leq N - 1 & ( Equation 3 )\end{matrix}$$

In the above Equation 3, j=\sqrt{−1}. Further, Equation 4 is an OFDMA signal vector.

x=[x₀x₁ . . . x_{N-1}]^{T} (Equation 4)

The OFDMA signal vectors for M users are transmitted through independent multi-path fading channels.

Meanwhile, each user is assigned with a predetermined number of subcarriers among all the subcarriers (for example, N subcarriers). An example of a method of assigning subcarriers for each user may include an interleaving scheme. According to the interleaving scheme, N subcarriers are divided into M interleaved subcarrier groups for M users, wherein the M interleaved subcarrier groups do not overlap each other. Equation 6 represents an m-th user symbol vector.

$$\begin{matrix}X = {\sum }_{m = 1}^{M} {X}_{m} & ( Equation 5 ) \\ {X}_{m} = {[ {\begin{matrix}{X}_{m , 0} & {X}_{m , 1} & … & X\end{matrix}}_{m , N - 1} ]}^{T} & ( Equation 6 )\end{matrix}$$

In the above Equations 5 and 6, X is the input symbol vector and 1≦m≦M. Equation 7 represents X_{m,k}.

$${X}_{m , k} = \{ \begin{matrix}{X}_{k} , & if k = m - 1 mod M \\ 0 , & otherwise\end{matrix} \qquad ( Equation 7 )$$

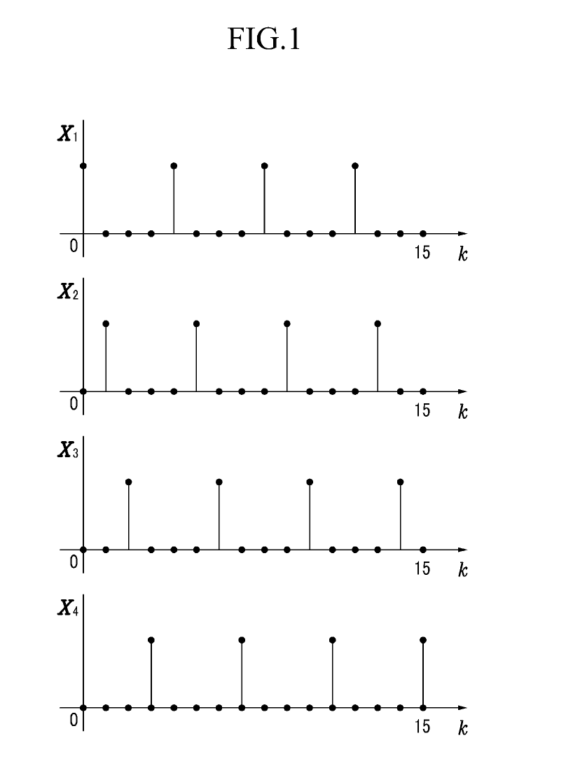

From Equation 7, it can be appreciated that each subcarrier is assigned only to one user. All the subcarriers included in one subcarrier group are assigned only to one user and the number of subcarriers assigned to each user is N/M. FIG. 1 illustrates an example in which the subcarriers are assigned in a frequency domain by the interleaving scheme in the case of 4 users (M=4) and a total of 16 subcarriers (N=16).

Meanwhile, the received signal vector in a time domain for the receiver of the OFDMA system depends on Equation 8.

r=[r₀r₁ . . . r_{N-1}]^{T} (Equation 8)

In the above Equation 8, N is the number of subcarriers and (·)^{T} is a transpose of vector. When the received signal vector is subjected to the N-point FFT, the received symbol vector may be obtained depending on Equation 9.

R=[R₀R₁ . . . R_{N-1}]^{T} (Equation 9)

In the above Equation 9, N is the number of subcarriers and (·)^{T} is a transpose of vector. An m-th user may obtain the received user symbol vector from the received symbol vector R depending on Equation 10.

Rₘ=[R_{m,0}R_{m,1} . . . R_{m,N-1}]^{T} (Equation 10)

In the above Equation 10, 1≦m≦M.

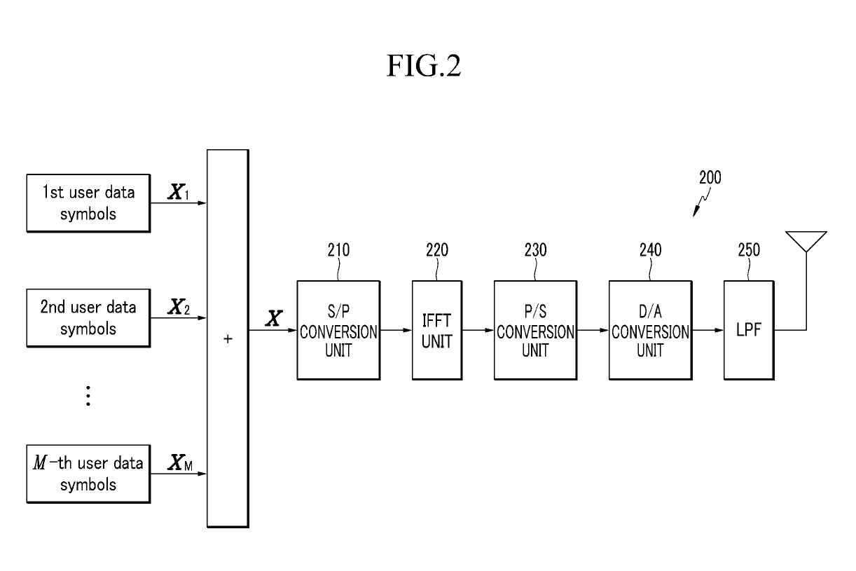

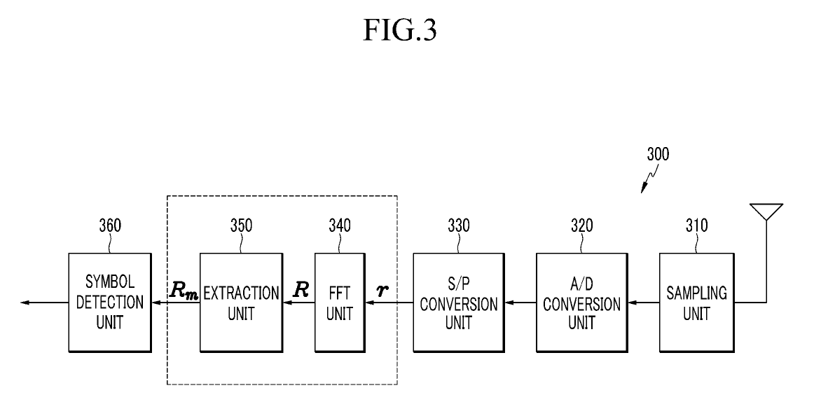

FIG. 2 is a diagram illustrating an example of a transmitter of the OFDMA system and FIG. 3 is a diagram illustrating an example of a receiver of the OFDMA system.

Referring to FIG. 2, the input symbol vector X is subjected to the N-point IFFT via a serial to parallel (S/P) conversion unit 210 and an IFFT unit 220. Further, the OFDMA signals for M users are transmitted via a parallel to serial (P/S) conversion unit 230, a digital to analog (D/A) conversion unit 240, and a low pass filter (LPF) 250.

Referring to FIG. 3, the received signal vector passing through a sampling unit 310, an analog to digital (A/D) conversion unit 320, and an S/P conversion unit 330 is subjected to the N-point FFT by a FFT unit 340 and is converted into the received symbol vector R. Further, the received symbol vector is extracted as the received user symbol vector Rₘ for the m-th user by an extraction unit 350. The signal processing performed by the FFT unit 340 and the extraction unit 350 is referred to as demodulation.

As described above, a receiver 300 of the OFDMA system performs N-point FFT on signals for all the subcarriers (for example, N subcarriers), that is, all the users (M users). Since the computational complexity of the N-point FFT is large, the receiver 300 may consume a large amount of power so as to compute unnecessary information.

According to the exemplary embodiment of the present invention, only the signals for each user among the OFDMA signals received by the receiver 300 of the OFDMA system are extracted and are subjected to N/M-point FFT, thereby reducing the computational complexity of FFT.

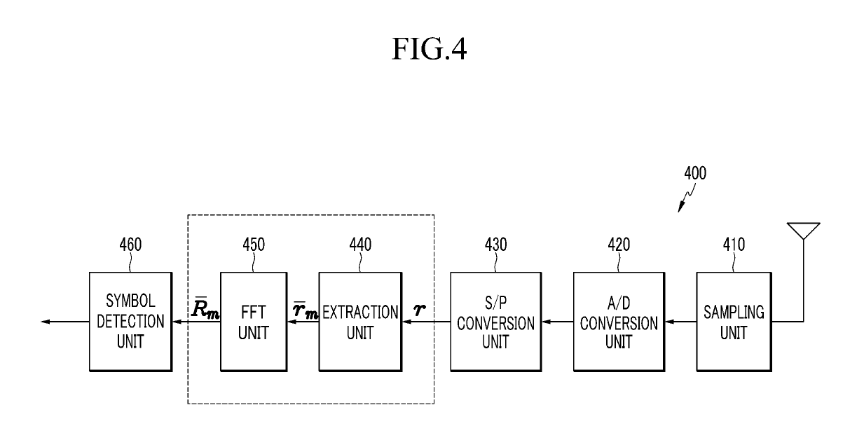

FIG. 4 is a diagram illustrating the receiver of the OFDMA system according to an exemplary embodiment of the present invention. The same contents as the receiver of FIG. 3 will be omitted.

Referring to FIG. 4, a receiver 400 receives the OFDMA signals for M users and extracts a received user symbol subvector R̅ₘ for the m-th receiver 400 for OFDMA signals.

For this purpose, an extraction unit 440 extracts the received user signal subvector r̅ₘ for the subcarrier assigned to the m-th user from the received signal vector r. The received user signal subvector r̅ₘ may be extracted by performing circular convolution on the received signal vector r and the user signal extraction vector tₘ, and by conversion of received user signal vector rₘ into received user signal subvector r̅ₘ. Here, the user signal extraction vector tₘ may be defined for each user.

An FFT unit 450 performs a fast Fourier transform on the received user signal subvector r̅ₘ to extract the received user symbol subvector R̅ₘ. Therefore, when the received signal vector r corresponds to N subcarriers assigned to M receivers, the FFT unit 450 is enough to perform an N/M-point FFT.

As described above, the receiver of the OFDMA system does not need to demodulate the signals for other users, thereby remarkably reducing the computations at the time of FFT.

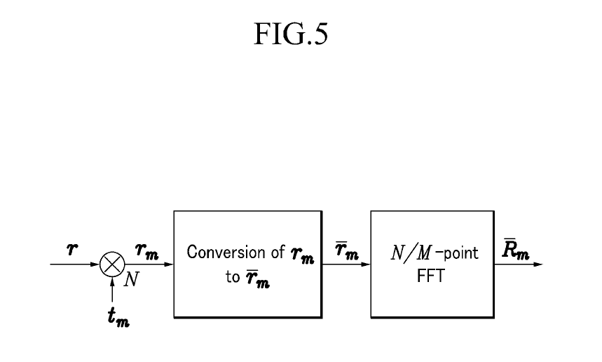

FIG. 5 is a diagram illustrating in detail a demodulation process of the receiver of the OFDMA system according to an exemplary embodiment of the present invention.

Referring to FIG. 5, the extraction unit 440 of the receiver 400 performs the circular convolution on the received signal vector r and the user signal extraction vector tₘ, and conversion of rₘ into r̅ₘ to extract the received user signal subvector r̅ₘ for the m-th user. This may be represented by Equation 11.

rₘ=tₘ\textcircled{x}_{N}r (Equation 11)

Here, the user signal extraction vector tₘ is a vector for extracting data for the m-th user from the received signal vector r including the data for M users and may be defined for each user. The user signal extraction vector tₘ includes M nonzero elements. Here, the m-th user signal extraction vector tₘ may be represented by Equation 12.

$${t}_{m} = {\frac{\sqrt{N}}{M} [ \underbrace{\begin{matrix}1 & 0 & … & 0\end{matrix}}_{\frac{N}{M}} \frac{\begin{matrix}{e}^{j \frac{2 π ( m - 1 )}{M}} & 0 & … & 0\end{matrix}}{\frac{N}{M}} \underbrace{\begin{matrix}{e}^{j \frac{2 π ( m - 1 )}{M} 2} & 0 & … & 0\end{matrix}}_{\frac{N}{M}} … \underbrace{\begin{matrix}{e}^{j \frac{2 π ( m - 1 )}{M} ( M - 2 )} & 0 & … & 0\end{matrix}}_{\frac{N}{M}} \underbrace{\begin{matrix}{e}^{j \frac{2 π ( m - 1 )}{M} ( M - 1 )} & 0 & … & 0\end{matrix}}_{\frac{N}{M}} ]}^{T} \qquad ( Equation 12 )$$

In the above Equation 12, when M=2, the user signal extraction vector tₘ may be represented by Equation 13.

$${t}_{1} = {\frac{\sqrt{N}}{2} [ \underbrace{\begin{matrix}1 & 0 & … & 0\end{matrix}}_{\frac{N}{2}} \underbrace{\begin{matrix}1 & 0 & … & 0\end{matrix}}_{\frac{N}{2}} ]}^{T} \\ {t}_{2} = {\frac{\sqrt{N}}{2} [ \begin{matrix}\underbrace{\begin{matrix}1 & 0 & … & 0\end{matrix}}_{\frac{N}{2}} & \underbrace{\begin{matrix}- 1 & 0 & … & 0\end{matrix}}_{\frac{N}{2}}\end{matrix} ]}^{T} \qquad ( Equation 13 )$$

When M=4, the user signal extraction vector tₘ may be represented by Equation 14.

$$\begin{matrix} & ( Equation 14 ) \\ {t}_{1} = \\ {\frac{\sqrt{N}}{4} [ \begin{matrix}\underbrace{\begin{matrix}1 & 0 & … & 0\end{matrix}}_{\frac{N}{4}} & \underbrace{\begin{matrix}1 & 0 & … & 0\end{matrix}}_{\frac{N}{4}} & \underbrace{\begin{matrix}1 & 0 & … & 0\end{matrix}}_{\frac{N}{4}} & \underbrace{\begin{matrix}1 & 0 & … & 0\end{matrix}}_{\frac{N}{4}}\end{matrix} ]}^{T} & \\ {t}_{2} = \\ {\frac{\sqrt{N}}{4} [ \begin{matrix}\underbrace{\begin{matrix}1 & 0 & … & 0\end{matrix}}_{\frac{N}{4}} & \underbrace{\begin{matrix}j & 0 & … & 0\end{matrix}}_{\frac{N}{4}} & \underbrace{\begin{matrix}- 1 & 0 & … & 0\end{matrix}}_{\frac{N}{4}} & \underbrace{\begin{matrix}- j & 0 & … & 0\end{matrix}}_{\frac{N}{4}}\end{matrix} ]}^{T} & \\ {t}_{3} = \\ {\frac{\sqrt{N}}{4} [ \begin{matrix}\underbrace{\begin{matrix}1 & 0 & … & 0\end{matrix}}_{\frac{N}{4}} & \underbrace{\begin{matrix}- 1 & 0 & … & 0\end{matrix}}_{\frac{N}{4}} & \underbrace{\begin{matrix}1 & 0 & … & 0\end{matrix}}_{\frac{N}{4}} & \underbrace{\begin{matrix}- 1 & 0 & … & 0\end{matrix}}_{\frac{N}{4}}\end{matrix} ]}^{T} & \\ {t}_{4} = \\ {\frac{\sqrt{N}}{4} [ \begin{matrix}\underbrace{\begin{matrix}1 & 0 & … & 0\end{matrix}}_{\frac{N}{4}} & \underbrace{\begin{matrix}- j & 0 & … & 0\end{matrix}}_{\frac{N}{4}} & \underbrace{\begin{matrix}- 1 & 0 & … & 0\end{matrix}}_{\frac{N}{4}} & \underbrace{\begin{matrix}j & 0 & … & 0\end{matrix}}_{\frac{N}{4}}\end{matrix} ]}^{T} & \end{matrix}$$

Further, the extraction unit 440 of the receiver 400 deforms the received user signal vector rₘ to be applied to the N/M-point FFT. That is, the extraction unit 440 transforms the received user signal vector rₘ for the m-th user into a received user signal subvector r̅ₘ, depending on Equation 15.

$${\overline{r}}_{m , n} = \sqrt{M} {e}^{- j \frac{2 π ( m - 1 ) n}{N}} {r}_{m , n} , 0 \leq n \leq \frac{N}{M} - 1 \qquad ( Equation 15 )$$

In the above Equation, N is the number of subcarriers and M is the number of users.

Further, the FFT unit 450 performs the N/M-point FFT on the received user signal subvector r̅ₘ depending on Equation 16.

R̅ₘ=FFT( r̅ₘ) (Equation 16)

In the above Equation 16, r̅ₘ is the received user signal subvector for the m-th user and R̅ₘ is the received user symbol subvector for the m-th user. R̅ₘ is configured of N/M data symbols and may be represented by Equation 17.

R̅_{m,i}=R_{m,Mi+m-1},0≦i≦N/M−1 (Equation 17)

In the above Equation 17, N is the number of subcarriers and M is the number of users.

Table 1 shows results obtained by comparing computations in the existing N-point FFT and the proposed demodulation scheme according to an exemplary embodiment of the present invention.

TABLE 1

| | Total number of | Total number of |
|---|---|---|
| | complex multiplications | complex additions |
| N-point FFT | $\frac{N}{2} {log}_{ 2} N$ | N log₂ N |
| Proposed scheme (M = 2, 4) | $\frac{N}{2 M} {log }_{2} \frac{N}{M} + \frac{N}{M}$ | $\frac{N}{M} {log }_{2} \frac{N}{M} + \frac{( M - 1 ) N}{M}$ |
| Proposed scheme (M > 4) | $\frac{N}{2 M} {log }_{2} \frac{N}{M} + \frac{( M - 3 ) N}{M}$ | $\frac{N}{M} {log }_{2} \frac{N}{M} + \frac{( M - 1 ) N}{M}$ |

As in Table 1, due to the N/M-point FFT according to the exemplary embodiment of the present invention, computations of the complex multiplications and the complex additions may be remarkably reduced, as compared with the existing N-point FFT

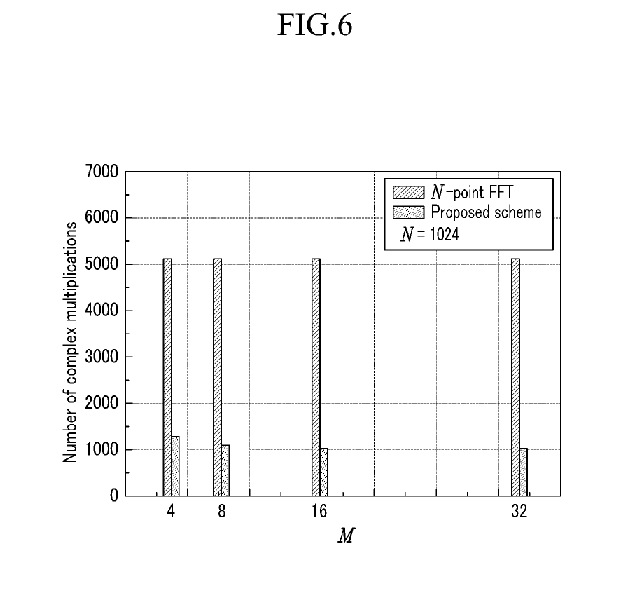

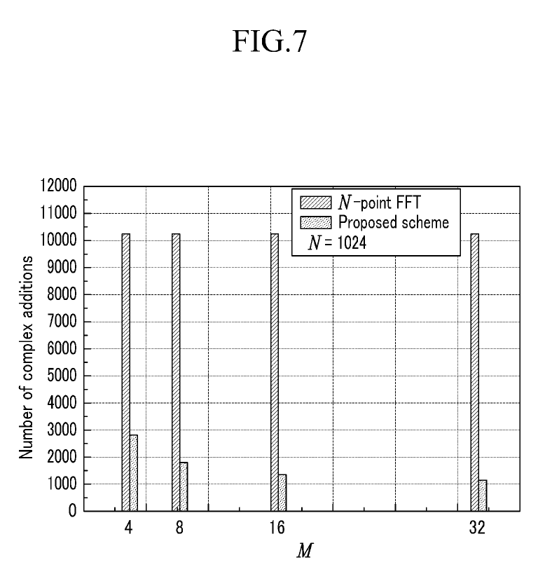

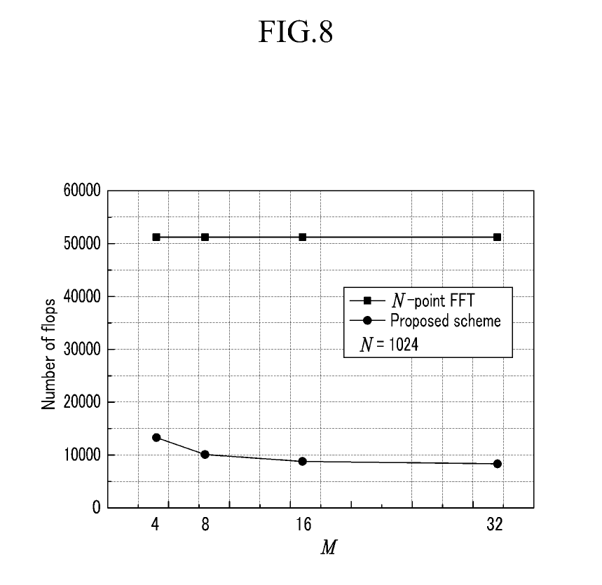

FIG. 6 is a graph illustrating results obtained by comparing complex multiplications in the existing N-point FFT and the proposed demodulation scheme according to an exemplary embodiment of the present invention and FIG. 7 is a graph illustrating results obtained by comparing complex additions in the existing N-point FFT and the proposed demodulation scheme according to an exemplary embodiment of the present invention. FIG. 8 is a graph illustrating results obtained by comparing the complex multiplications and the complex additions in the existing N-point FFT and the proposed demodulation scheme according to an exemplary embodiment of the present invention based on the number of flops. Here, FIGS. 6 to 8 show results of simulating the case of N=1024, M=4, 8, 16, and 32.

As illustrated in FIGS. 6 to 8, according to the exemplary embodiment of the present invention, it can be appreciated that the computations, such as the complex multiplications, the complex additions, and the like, are remarkably reduced.

The foregoing exemplary embodiments of the present invention are not implemented only by an apparatus and a method, and therefore, may be realized by programs realizing functions corresponding to the configuration of the exemplary embodiment of the present invention or recording media on which the programs are recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A receiver in an orthogonal frequency division multiple access (OFDMA) system, comprising:
an extraction unit that extracts received user signal subvectors for subcarriers assigned to the receiver from received signal vectors received from a transmitter; and
a fast Fourier transform (FFT) unit that performs a fast Fourier transform on the received user signal subvectors.

2. The receiver of claim 1, wherein:
the extraction unit performs circular convolution on the received signal vectors and the user signal extraction vectors, and converts the received user signal vector into the received user signal subvector.

3. The receiver of claim 2, wherein:
the user signal extraction vectors are defined for each receiver.

4. The receiver of claim 1, wherein:
the FFT unit performs a fast Fourier transform on the received user signal subvectors to extract received user symbol subvectors.

5. The receiver of claim 1, wherein:
when the received signal vectors are received signal vectors for N subcarriers assigned to M receivers, the FFT unit performs an N/M-point FFT.

6. A signal processing method of a receiver in an orthogonal frequency division multiple access (OFDMA) system, comprising:
extracting received user signal subvectors for subcarriers assigned to the receiver from received signal vectors received from a transmitter; and
performing a fast Fourier transform on the received user signal subvectors.

7. The signal processing method of claim 6, wherein:
the received user signal subvectors are extracted by performing convolution on the received signal vectors and user signal extraction vectors, and by conversion of received user signal vectors into received user signal subvectors.

8. The signal processing method of claim 7, wherein:
the user signal extraction vectors are defined for each user.

9. The signal processing method of claim 7, wherein:
the user signal extraction vectors have nonzero elements that correspond to the total number of users.

10. The signal processing method of claim 6, wherein:
when the received signal vectors are received signal vectors for N subcarriers assigned to M receivers, the FFT unit performs an N/M-point FFT.

11. The signal processing method of claim 6, wherein:
received user symbol subvectors for the receiver are extracted as a result of the fast Fourier transform.

12. The signal processing method of claim 11, wherein:
when the received signal vectors are received signal vectors for N subcarriers assigned to M receivers, the received user symbol subvectors are configured of N/M data symbols.
